(19) United States
(12) Patent Application Publication
(10) Pub. No.: US 2026/0253971 A1
(43) Pub. Date: Aug. 27, 2026

(54) ELECTROLYTE FOR ULTRA EFFICIENT STATIC ZINC-BASED BATTERY

(71) Applicants: OFFGRID ENERGY LABS PRIVATE LIMITED, New Delhi (IN); OFFGRID ENERGY LABS INC., San Francisco, CA (US)

(72) Inventors: Brindan Tulachan, Kanpur (IN); Sumanta Chakrabarty, Murshidabad (IN)

(73) Assignees: OFFGRID ENERGY LABS PRIVATE LIMITED, New Delhi, DL (IN); OFFGRID ENERGY LABS INC., San Francisco, CA (US)

(21) Appl. No.: 19/161,039

(22) PCT Filed: Feb. 28, 2024
(86) PCT No.: PCT/IB2024/051890

§ 371 Date: Aug. 29, 2025

(30) Foreign Application Priority Data
Mar. 1, 2023 (IN) 202311013824

(51) Int. Cl. H01M 10/36

(52) U.S. Cl. CPC H01M 10/365; H01M 2300/0005

(57) ABSTRACT

An electrolyte of a static zinc-based battery, includes a) zinc bromide in molar concentration from 1.5M to 3.0M, b) tetraethylammonium bromide as a bromine complexing agent in half of the molar concentration of the zinc bromide, c) a glycol based anti-freezing agent in molar concentration from 1.0M to 2.0M, d) zinc chloride as supporting ionic conducting agent in molar concentration from 1.0M to 4.0M, and e) an additional supporting ionic conducting agent in molar concentration from about 2.0M to 4.0M. The electrolyte minimizes the self-discharge of the static zinc-based battery and improves the energy density of the static zinc-based battery.

### TECHNICAL FIELD

The present disclosure relates to a novel electrolyte of a static Zinc-based battery, and particularly to an electrolyte of (for) a Zinc-Bromine redox static battery, where the electrolyte comprises zinc bromide and a specific bromine complexing agent along with other electrolyte ingredients, where the bromine complexing agent is used in a controlled amount that arrest highly soluble tribromide ions formed upon charging process from the liquid electrolyte in a solid form.

### BACKGROUND

Fossil fuel resources are not only inherently finite but also their combustion results in environmental problems, making the research community focus more towards green, renewable, and sustainable energy resources for energy generation, utilization, and storage. In order to exploit the sustainable energy resources, metal halide electrochemical cells were introduced for their high efficiency, low cost, durability, and eco-friendly rechargeable energy storage devices. However, the metal halide electrochemical cells undergo degradation over time, leading to a decrease in performance and a limited cycle life. In addition, the metal halide electrochemical cells have a limited operating temperature range and may not be suitable for extreme conditions, which limits the practical use, which is not desirable.

In recent times, the tremendous improvement in cost and performance of lithium-ion batteries (LIBs) have made them market dominators in the rechargeable energy storage devices segment. The desire to lower costs and increase energy density, as well as growing concern over Li ion's natural resource, has pushed the development of the so-called “beyond Li-ion” technologies.

In recent years, flow batteries with multiple redox couples are approaching as one of the most promising alternatives for large-scale rechargeable energy storage devices. So far, a variety of energy storage device chemistries involving metal ions of sodium (Na), potassium (K), magnesium (Mg), and zinc (Zn) have been investigated as a possible alternative to the currently existing rechargeable energy storage devices. Out of this Zn based energy storage devices are considered a promising alternative candidate for the large-scale grid applications due to their low cost, eco-friendliness, high safety, material abundance, and ease of manufacturing.

Typically, electrochemical cells are metal halogen cells in which the anode material most commonly employed is zinc and the most commonly employed cathodic halogen is bromine. Such metal halogen electrochemical cells are favoured due to their extremely high theoretical energy density. For example, a zinc bromine cell has a theoretical energy density of 200 watts hours per pound (Wh/lb) i.e. 720,000 joules per kilogram (J/kg) and an electric potential of about 1.85 volts per cell. However, such electrochemical cells of the foregoing type are known to suffer from a number of technical issues. Most of the technical issues are associated with side reactions, which may occur in such electrochemical cells. For example, during the charging process, free bromine is produced in the electrochemical cells. The free bromine is available for electrochemical reaction with the zinc anode, thereby resulting in self-discharge of the electrochemical cells. Additionally, there is a tendency for hydrogen gas to be generated when considerable amounts of the free bromine are present in an aqueous phase. Zinc-bromine flow batteries are appealing mainly due to their long cycling life and are semi-deposition flow batteries. In a typical zinc-bromine battery (flow and static), zinc bromide acts as both active material and an ionic conductor. The zinc-bromine liquid battery is used as a combination of a flow battery technology and an energy storage device and has a very high application prospect in the field of rechargeable energy storage devices. The electrochemical reactions can be depicted as follows:

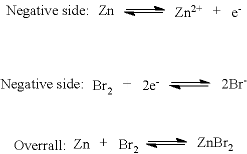

During charging, Br₂ is generated at the positive electrode and further complexes with bromide ions (Br) present in aqueous media to form highly soluble Br₃⁻ ions (tribromide ions), while zinc is deposited at the negative electrode simultaneously. Reverse reactions happen at the respective electrodes during the discharge process. Although the highly soluble Br₃⁻ species accelerates the redox kinetics and diffuses to a zinc electrode by cross-diffusion, the technical issue is that they directly react with the plated zinc and therefore trigger self-discharge and low coulombic efficiency. Another existing issue for the zinc-based based energy storage devices is the dendritic Zn deposition, which potentially triggers an internal short circuit. Such technical challenges are alleviated with the multiple strategies of a standard zinc bromide flow battery. However, it is to be understood that all the existing approaches are compromised at the expense of cell resistance, energy efficiency (typically <60%), increased system size, and complexity. Overall, such conventional approaches sharply raise the capital costs from $8 per kWh based on ZnBr₂ electrolyte and carbon electrode to over $200 per kWh for a battery system, which is not superior at all when compared with the conventional Li-ion technology. Further, the flowable and corrosive Br²/Br³⁻ species reduce the reliability of the conventional battery systems, leading to cell failure by parts corrosion instead of the intrinsic redox chemistry. Secondary hydrolysis reactions are also problematic for such types of storage batteries when the electrolytes are formulated with excess free water, because bromate solids form, which in turn reduces the amount of available bromide/bromine that can under reduction or oxidation in the electrochemical cell.

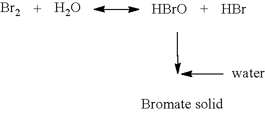 [SMILES: "Br2" ; O ; "HBrO" ; Br]

To solve the above-mentioned inherent problems of the conventional zinc-bromine flow batteries, the development of a static zinc-bromine battery that can be produced on a commercial scale is necessary. One of the major technical problems in the development of the static zinc-bromine battery is the development of efficient electrolytes that can prevent cross-diffusion and provide high energy efficiency with long cycle life. Moreover, the zinc dendrite formation is difficult to solve and has been a longstanding problem for several decades.

U.S. Pat. No. 3,640,771 discloses a metal bromide aqueous electrolyte battery having a limited concentration of the metal bromide in solution in the electrolyte. Moreover, when the battery is charged, the remaining dissolved metal bromide salt and the total free bromine in the electrolyte are in minor quantity, the remaining free bromine is retained in a bromine-adsorbent layer provided at the cathode. The patent further provides a secondary battery comprising an anode and a cathode including a bromine-adsorbent layer capable of adsorbing at least half its weight of molecular bromine when the battery is charged. The secondary battery further includes an electrolyte comprising a divalent electroplatable metal bromide salt dissolved in an aqueous medium, wherein the bromine adsorbent is an activated carbon.

U.S. Pat. No. 4,105,829 discloses a metal halogen cell, which employs a circulating electrolyte system containing a complexing agent to effectively remove cathodic halogen from the electrolyte during the charging of the metal halogen cell. The complexing substituent or complexing agent is one which, in the presence of halogen, forms a water-immiscible halogen complex. This complex is separated and stored external to the metal halogen cell during charging but is returned to the metal halogen cell during discharge. Despite of certain efficiency achieved with the above-mentioned zinc-bromine battery/cell, the coulombic inefficiencies persist. This loss in coulombic efficiency is attributed to the reaction of un-complexed dissolved bromine present in the metal halogen cell with elemental zinc.

Chinese patent, CN 108711633 B discloses electrolyte for the zinc-bromine flow battery comprising a positive electrolyte and a negative electrolyte, which is respectively composed of zinc bromide, zinc chloride, a complexing agent, an anti-dendrite agent, a wetting agent, and water. This patent discloses use of 1-(carboxymethyl) pyridine-1-onium bromide as a complexing agent in large amounts in combination with an anti-dendrite agent and the wetting agent, which are added into the electrolyte for the zinc-bromine flow battery so that the current efficiency of the zinc-bromine flow battery can be increased. However, the use of a large amount of bromine complexing agents, such as pyridinium compounds makes the device very expensive. Also, such complexes are not compatible with all Zinc-bromine batteries. Further, this has the issue of high self-discharge.

Another Chinese patent application, CN 110767927 A, discloses an electrolyte for a zinc-bromine liquid battery, which mainly comprises zinc bromide, a bromine complexing agent in extremely low amounts, a dendrite inhibitor, a conductive agent, a pH regulator, and distilled water. The electrolyte related to the prior art is mainly suitable for a flow battery system with a circulating device, and the flow battery system is complex in structure, high in manufacturing cost, and not suitable for large-scale production and use. Journal of Power Sources 384 (2018) 232-239, provides a solution for dendrite growth by using an electrolyte modified with methanesulfonic acid. However, highly acidic solutions reduce the pH of the electrolyte to a significant value. At lower pH, Zinc-Bromine batteries suffer hydrogen evolution reaction and further reduce battery efficiency. Further gas evolution during cycling is a safety concern on a commercial scale.

Chinese patent CN113991191A discloses an aqueous Zinc-Bromine battery, which is used to improve poor battery reversibility, cross-contamination, low Coulomb efficiency, and cycle instability. This patent application talks about use of Ketjen Black® modified carbon felt positive electrode in combination with an electrolyte containing tetrapropylammonium bromide as bromine complexing agent along with zinc dendrite inhibitor, where the pH of the electrolyte is maintained by using pH adjusting agents such as sulphuric acid solution and the like.

US patent application US 20190198881 A1, discloses electrolyte composition for Zinc-Bromine battery, and said electrolyte comprises zinc bromide and small amount of quaternary ammonium agents. This patent application suggests using N-methyl-N-ethylmorpholinium bromide (MEMBr) and related quaternary ammonium agents in an amount of less than 0.3 times of zinc bromide but has the issue of high self-discharge.

In view of the existing technical problems and unsolved issues in prior known literatures, there is a need for an advanced electrolyte for static Zinc-based battery, and overcomes the problems present with existing electrolytes for zinc-based rechargeable energy storage devices.

### SUMMARY

The present disclosure provides an electrolyte of (for use in) a static zinc-based battery, particularly a Zinc-Bromine redox static battery. One non-limiting advantage of the electrolyte of the present disclosure is that the disclosed electrolyte significantly minimizes self-discharge, which is one of the major technical problems of Zinc-Bromine static batteries. Furthermore, the electrolyte manifests a surprising effect which not only minimizes the self-discharge but also enables to use of a more active ingredient, i.e., the Zinc Bromide, which is observed to directly enhance the energy density of the Zinc-Bromine static battery. Any Zinc-Bromine static battery when using the electrolyte manifest improved performance in terms of increased energy capacity and energy efficiency, for example, more than 20%, just by only replacing convention electrolyte with the electrolyte of the present disclosure. In other words, improvements in battery performance may be achieved even if no hardware or operational changes are done in a given Zinc-Bromine static battery when the electrolyte (may also referred to as an aqueous electrolytic composition) of the present disclosure is used.

Accordingly, one aspect of the present disclosure provides an electrolyte of a static zinc-based battery comprising:
a) zinc bromide in molar concentration ranging from 1.5M to 3.0M;
b) tetraethylammonium bromide as a bromine complexing agent in half of the molar concentration of the zinc bromide;
c) a glycol based anti-freezing agent in molar concentration ranging from 1.0M to 2.0M;
d) zinc chloride as supporting ionic conducting agent in molar concentration ranging from 1.0 M to 4.0 M; and
e) an additional supporting ionic conducting agent in molar concentration ranging from 2.0M to 4.0M.

It is known that the main challenges of the Zinc Bromide based batteries include (a) low current densities during cycling, (b) dendrite formation, (c) high viscosity of the electrolyte polybromide phase in low states of charge, (d) self-discharge and (e) pH variations during operation. The present disclosure has dealt with and solved the abovementioned problems, especially a surprising technical effect is achieved when the tetraethylammonium bromide is present in half of the molar concentration of the zinc bromide. Surprisingly, during experimentation, when the Tetraethylammonium bromide (TEAB) was used as the complexing agent in about half of the molar concentration of the zinc bromide when zinc bromide in molar concentration from about 1.5M to 3.0M, a significant improvement in reduction in self-discharge was achieved. The presence of the glycol-based anti-freezing agent, the zinc chloride, and the additional supporting ionic conducting agent specified in corresponding molar concentration further manifests a synergistic effect to significantly contribute to solving the aforementioned problems, especially the dendrite formation problem and the self-discharge.

As envisaged herein an electrolyte of static zinc-based battery is provided, comprising: a) zinc bromide in molar concentration ranging from 1.5M to 3.0M, b) tetraethylammonium bromide as a bromine complexing agent in half of the molar concentration of the zinc bromide to arrest Br₂/Br₃ species (tribromide ions) in a solid form; c) monoethylene glycol as an anti-freezing agent in molar concentration ranging from 1.0M to 2.0M; d) zinc chloride as supporting ionic conducting agent in molar concentration ranging from 1.0M to 4.0M; and e) one or more additional supporting ionic conducting agents selected from potassium chloride or ammonium chloride or a combination thereof, wherein each of the potassium chloride or the ammonium chloride or their combination is in molar concentration ranging from 2.0M to 4.0M.

In an implementation, the additional supporting ionic conducting agent is selected from potassium chloride or ammonium chloride or a combination thereof.

In an implementation, the electrolyte is free of pH maintaining agents and buffering agents.

In an implementation, the electrolyte is prepared in absence of external heat energy.

The zinc bromide and the tetraethylammonium bromide is present in the ratio of 2:1. Beneficially, the optimized molar ratio of 2:1 between the zinc bromide and the complexing agent (specifically, TEAB) and selection of salts in specific concentration range allows the dissolution of >1.25M of TEAB (or even higher than that) in the presence of ZnBr₂ (2.5 M) even at room temperature. The higher dissolution of the complexing agent (e.g., the TEAB) not only minimizes the self-discharge but also allows to use of more active ingredient (i.e., zinc bromide), which directly enhances the energy density of the Zinc-Bromine static battery.

In an implementation, the monoethylene glycol is present in molar concentration of 1.35M.

In an implementation, the zinc chloride is present in the molar concentration of 1.7M.

In an implementation, the additional supporting ionic conducting agent is present in the molar concentration of 3.0M.

In an implementation, the electrolyte is maintained at a pH value ranging from 3-5 in absence of pH maintaining agents and buffering agents.

### BRIEF DESCRIPTION OF THE DRAWINGS

Embodiments of the present disclosure will now be described, by way of example only, with reference to the following diagrams wherein:

FIG. 1 is a diagram representing cyclic voltammogram of an electrolyte on a carbon/carbon symmetrical cell at a scan rate of 5 mV/s, in accordance with an embodiment of the present disclosure;

FIG. 2 is a diagram representing cyclic voltammogram of an electrolyte on a carbon/carbon symmetrical cell at a scan rate of 5 mV/s within the potential range 0.5 V to 2.25 V, in accordance with another embodiment of the present disclosure;

FIG. 3 is a diagram representing a charge-discharge zinc-bromine static battery profile using the electrolyte and carbon-based electrodes in accordance with another embodiment of the present disclosure; and

FIG. 4 is a diagram representing energy density of a static zinc-bromine battery and long cycling stability using the electrolyte, in accordance with another embodiment of the present disclosure.

### DETAILED DESCRIPTION OF EMBODIMENTS

### Definitions

The term “static energy battery” shall mean an energy storage device with physically non-flowing or non-moving electrolyte or cathode electrode or anode electrode materials.

The term “electrolyte solution” shall mean electrolyte solution that comprises ions, and use water as the solvent. It contains aqueous solvent and ions, atoms or molecules that have lost or gained electrons, and is electrically conductive.

The term “ambient temperature” shall mean temperature falling in the range of 25 to 30° C.

When referring to the concentration of components or ingredients for eutectic electrolytes, Moles shall be based on the total volume of the aqueous electrolyte.

### DESCRIPTION

Certain embodiments of the disclosure provide an electrolyte (i.e., an aqueous electrolyte composition) for use in a static zinc-based battery, particularly Zinc-Bromine redox static battery.

In a first example, typically, it is observed that in the presence of zinc bromide, dissolution of a complexing agent (at ambient temperature) at higher concentration (>0.3 M) is technically challenging and not yet achieved by conventional electrolytes or reported yet, as there is precipitation in the form of bromozincate, which is not desirable.

In a second example, the zinc dendrite formation problem is difficult to solve and has been a longstanding problem for several decades. It is known that the dendritic zinc growth can somehow be suppressed by adding a small amount of inorganic or organic additives, but performance in terms of dendritic zinc growth is still not satisfactory. Additionally, it was observed that addition of external additive significantly reduces the ionic conductivity, naturally affects the reaction kinetics and, as a consequence, overall cell performance of Zinc-Bromine redox static battery got affected.

In a third example, it is known that bromine is a very good electro-active species, with improved and reversible kinetics. Typically, the reduction of diatomic bromine to two bromide ions has been used in the electrolyte fluids for decades. Battery types with functions relying on the bromine half reaction include zinc bromide, hydrogen bromide, and vanadium bromide batteries. However, even at relatively low concentrations, diatomic bromine has a propensity to form a vapor phase, which separates out of the liquid electrolyte, interfering with the recharge of bromine-containing batteries. For this reason, it is necessary to keep the free diatomic bromine concentration in the electrolyte low enough, such that vapor phase formation does not occur, which is achieved via bromine complexing agents. Such bromine complexing agents reduce reactivity and vapor pressure without changing electrochemical properties of bromine ions. Prior art discloses the use of certain morpholine and pyridinium-based quaternary ammonium salts as bromine complexing agents, however, the major drawback of their use as complexing agents for bromine is that they are not always compatible with different bromide chemistries. Moreover, currently, a proper concentration in which the complexing agent is to be used with respect to zinc bromide is not known in the existing art.

To overcome at least the technical problems discussed in the above examples and increase performance of the Zinc-Bromine redox static battery, in one aspect of the present disclosure, an improved electrolyte (i.e., an improved aqueous electrolyte composition) is provided for high-performance static Zinc-Bromine batteries.

Accordingly, in an aspect of the present disclosure, an electrolyte is provided for use in a static zinc-based battery. The electrolyte comprises: a) zinc bromide in a molar concentration ranging from 1.5M to 3.0M; b) tetraethylammonium bromide (TEAB) as a bromine complexing agent in about half of the molar concentration of the zinc bromide; c) a glycol-based anti-freezing agent in a molar concentration ranging from 1.0M to 2.0M; d) zinc chloride as supporting ionic conducting agent in molar concentration ranging from 1.0M to 4.0M; and e) an additional supporting ionic conducting agent in molar concentration from about 2.0M to 4.0M. The zinc bromide which is an active ingredient takes part in the redox reaction. The higher the zinc bromide concentration, the higher the energy density achieved. The quaternary ammonium salt that is used as the bromine complexing agent is specifically the tetraethylammonium bromide (TEAB) (i.e., C₈H₂₀NBr). Surprisingly, during experimentation, when the Tetraethylammonium bromide (TEAB) was used as the complexing agent in about half of the molar concentration of the zinc bromide when zinc bromide in molar concentration from about 1.5M to 3.0M, a significant improvement in reduction in self-discharge was achieved.

As self-discharge is one of the major concerns for Zinc-Bromine chemistry, effective utilization of a complexing agent plays a crucial role in improving performance. By use of the TEAB as the suitable complexing agent in a controlled manner, the bromine cross-over is locked, and the self-discharge is reduced significantly. Higher solubility of zinc bromide (ZnBr₂) can enhance the capacity of the battery, but due to the lower solubility of complexing agents in electrolytes, it generally suffers from high self-discharge. It was observed that the important factor for achieving greater efficiency of zinc bromide electrolytes is the amount of complexing agent used for a practical application. The disclosed electrolyte having a specific bromine complexing agent in its optimized composition, as disclosed in the above aspect of the present disclosure, is capable to arrest the self-discharge (almost) completely.

Present disclosure provides a specific ratio and specific selection of a quaternary ammonium salt that allow the dissolution of 1.25M (or even higher than that) of quaternary ammonium salt, particularly, the tetraethyl ammonium bromide in the presence of ZnBr₂ (2.5 M) even at room temperature. During experimentation, a surprising effect was found that works specifically at a specific and optimized molar ratio between the zinc bromide and the complexing agent of tetraethyl ammonium bromide, which is enough to capture almost the entire Br₃ ion and prevent the self-discharge of the Zinc-Bromine static battery. The optimized molar ratio between the zinc bromide and the complexing agent (specifically tetraethylammonium bromide (TEAB)) to arrest the self-discharge is experimentally found to be 2:1. The optimized molar ratio of 2:1 between the zinc bromide and the complexing agent (specifically, TEAB) and selection of salts in specific concentration range allows the dissolution of >1.25M of TEAB (or even higher than that) in the presence of ZnBr₂ (2.5 M) even at room temperature. The higher dissolution of the complexing agent (e.g., the TEAB) not only minimizes the self-discharge but also allows to use of more active ingredient (i.e., zinc bromide), which directly enhances the energy density of the Zinc-Bromine static battery.

Generally, the aqueous electrolyte solution, which circulates through the cathodic side during the cell charge contains the complexing agent, which is capable of forming a water-immiscible liquid phase upon complexing with Br₂/Br₃⁻ species, mainly tribromide ions. Thus, the elemental bromine generated at the cathodic side during cell charge reacts almost instantaneously with the water-soluble complexing agent, to form a water-immiscible oily phase, thereby effectively avoiding the diffusion of the elemental bromine, the cross-contamination of the positive and negative electrodes, and the like. In the present disclosure, there is provided the electrolyte (i.e., an aqueous electrolyte composition) for high-performance static Zinc-Bromine batteries, where effective utilization of a complexing agent in a controlled amount arrests the Br₃⁻ ions in a solid form resulting in almost wholly diminished intrinsic self-discharge. Beneficially as compared to conventional approaches, the electrolyte of the present disclosure manifest synergetic effects that improves battery stability and works without the use of expensive ion exchange membranes.

As explained above, the bromine-complexing agent is added to the electrolyte of a zinc-bromine battery to minimize the vapor pressure of elemental bromine. Properties considered important for screening the bromine-complexing agents include stability against crystallization down to low ambient temperatures, high conductivity of the electrolyte, low to negligible viscosity of the complex-containing solid phase, and the ability to maintain a minimal, yet effective, amount of ‘free bromine’ in the aqueous phase. Herein, the bromine complexing agent, TEAB, combines with tribromide ions on the positive electrode side during charging to form a bromine complex compound (in a solid form) and plays an important role of retaining electric energy.

In accordance with an embodiment, the electrolyte comprises the zinc bromide and the quaternary ammonium salt in a ratio of 2:1, where the quaternary ammonium salt arrests thribromide ions in a solid form when used in a controlled amount in such specific ratio. The quaternary ammonium salt is tetraethylammonium bromide (TEAB). TEAB is present in such an amount that the ratio of zinc bromide to TEAB is about 2:1 in the electrolyte. The use of the TEAB as the bromine complexing agent prevents dendrite formation due to its interaction chemistry with the free bromide ions. Further, the TEAB arrest the tribromide ions in solid form due to which the electrolyte possesses high ionic conductivity and low viscosity, which makes it suitable for practical application.

It is known that the dendritic zinc growth problem can somehow be suppressed by adding small amount of inorganic/organic additives, but the performance of Zinc Bromide based batteries while using the conventional electrolytes was still not satisfactory (e.g., low performance). Further, in conventional approaches, the addition of external additive significantly reduces the ionic conductivity, and naturally affects the reaction kinetics and as a consequence, overall cell performance got affected. Beneficially as compared to conventional electrolytes, the electrolyte of the present disclosure does not require the addition of external additives to control Zinc dendrite formation. The TEAB when used as the complexing agent alters the electrodeposition of the zinc from a dendritic growth to a non-dendritic development as the polar TEA⁺ ion (tetraethyl ammonium ion) prefers to be adsorbed on the zinc nucleus, blocking the strong electric field and regulating the ion distribution on the interface. Hence, the present disclosure provides the electrolyte that significantly improves the performance of the static zinc-based battery where the composition of the electrolyte is free from anti-dendrite agents.

Some additional advantages of the electrolyte are: a) cost-effective, energy-efficient and scalable process in electrolyte production; b) eco-friendly and non-toxic electrolyte; c) non-flammable electrolyte; d) suitable for zinc bromide energy storage applicable for a range varying from electric vehicles to grid storage; and e) the electrolyte is compatible with commercially available Absorbed Glass Mat (AGM) separator, polyethylene (PE), or polypropylene (PP) separators.

In accordance with an embodiment, the glycol based anti-freezing agent is selected from the group comprising of monoethylene glycol, propylene glycol, 1,3-butylene glycol, polyethylene glycol 200, polyethylene glycol 400, or a combination thereof. The use of glycol-based anti-freezing agents in the electrolyte can prevent the electrolyte from freezing in low temperatures, thereby maintaining the performance and longevity of the static zinc-based battery.

In accordance with an embodiment, the glycol-based anti-freezing agent is monoethylene glycol in the molar concentration ranging from about 1.0M to 2.0M, preferably 1.35M. It was observed during experimentation that monoethylene glycol in the molar concentration ranging from about 1.0M to 2.0M especially was more effective and also contributed to the thermal stability of the electrolyte suitable for versatile weather conditions. The electrolyte remained stable and effective at a temperature range varying from −15° C. to >50° C.

The additional supporting ionic conducting agent is selected from potassium chloride or ammonium chloride or a combination thereof. Specifically, in a preferred embodiment, two supporting ionic conducting agents are used, which include the zinc chloride in the molar concentration ranging from about 1.0M to 4.0M, preferably 1.7M along with potassium chloride in the molar concentration ranging from about 2M to 4M, preferably 3M. Alternatively, in another embodiment, ammonium chloride in the molar concentration ranging from about 2M to 4M, preferably 3M is used instead of the potassium chloride along with the zinc chloride in the molar concentration ranging from about 1M to 4M, preferably 1.7M. Ammonium chloride or potassium chloride, or both salts can be used in an optimized ratio for other variants of electrolyte. Different colligative properties of both chloride salts help to design electrolytes as per requirement like low temperature (−20° C.) by tuning the composition.

Although the zinc bromide acts as a conducting agent, poor ionic conductivity is still an issue for the electrolyte. In the present disclosure, it is observed that using supporting electrolytes like Potassium chloride and/or ammonium chloride enhances the ionic conductivity but does not affect other properties significantly like pH. In known commercial batteries, to enhance the ionic conductivity, highly acidic solutions (in some cases mild acid) are used as one of the major components in zinc-bromine-based electrolytes, which reduces the pH of the electrolyte to a significant value. At lower pH, the zinc-bromine battery suffers from hydrogen evolution and further reduces battery efficiency. Further gas evolution during cycling is a safety concern on a commercial scale. Hence, in yet another embodiment, the present disclosure provides the electrolyte in which no such acid(s) is used, and the pH of the electrolyte is maintained at a particular value that is in the range of 3.5 to 5.0, preferably the pH of about 4.7, such that no such gas evolution occurs during cycling.

In accordance with an embodiment, the electrolyte is free of pH maintaining agents and buffering agents. Typically, according to previously reported articles, researchers preferred to use buffering agent and/or pH maintaining agent to maintain the pH of the electrolyte throughout the cycling for an extended period to avoid side reactions at relatively lower or higher pH. However, it is observed that the use of such buffering agent reduces the ionic conductivity of the electrolyte. Hence, in a preferred embodiment, the present disclosure provides the electrolyte that is free from the buffering agent and the pH maintaining agents, and the pH of the electrolyte during cycling is maintained at about 4.7, even without using such buffering agent and pH maintaining agents. In other words, in accordance with an embodiment, the electrolyte is maintained at a pH of about 4.7 in absence of pH maintaining agents and buffering agents.

In accordance with an embodiment, the electrolyte is prepared in absence of external heat energy. As no external heat energy is needed to prepare the electrolyte, a scalable and cost-effective process of production is achieved. The production of electrolyte in bulk quantity thus is cost-effective, energy-efficient, and scalable. In the in absence of external heat energy, thermal decomposition of the electrolyte components are avoided, and the risk of thermal runaway reactions are reduced. This further results in a stable and homogeneous electrolyte, which can help to ensure the performance and safety of the static zinc-based battery.

In another aspect of the present disclosure, an electrolyte of static zinc-based battery is provided, where the electrolyte comprises: a) zinc bromide in molar concentration from about 1.5M to 3.0M, b) tetraethylammonium bromide as a bromine complexing agent in about half of the molar concentration of the zinc bromide to arrest tribromide ions in a solid form, c) monoethylene glycol as an anti-freezing agent in molar concentration from about 1.0M to 2.0M, d) zinc chloride as supporting ionic conducting agent in molar concentration from about 1.0M to 4.0M, and e) one or more additional supporting ionic conducting agents selected from potassium chloride or ammonium chloride or a combination thereof, wherein each of the potassium chloride or the ammonium chloride or their combination is in molar concentration from about 2.0M to 4.0M, where the electrolyte is free of pH maintaining agents and buffering agents. High energy efficiency (around 85%) can be achieved using this electrolyte, whereas, for zinc-bromide chemistry, practically energy efficiency of 65-70% is generally achieved with other conventional electrolytes. No such buffering agent is required to maintain the pH during the cycling for the electrolyte of the present disclosure. In the context of batteries, for example, cycling refers to the process of repeatedly charging and discharging a battery, for example, to test its performance, capacity, and durability. This composition of electrolyte further prevents dendrite formation, due to the interaction chemistry of the complexing agent, as the tetraethylammonium bromide in about half of the molar concentration of the zinc bromide arrests tribromide ions in the solid form. The tetraethylammonium bromide in about half of the molar concentration of the zinc bromide completely locks the bromine cross-over and reduces the self-discharge significantly. In other words, the addition of tetraethylammonium bromide (TEAB) in a concentration equal to half the molar concentration of zinc bromide effectively prevents the movement or “cross-over” of free bromine molecule and tribromide ions and reduces the self-discharge of the electrolyte solution. The self-discharge refers to a decrease in the loss of stored energy in the solution over time. By controlling the bromine cross-over and reducing self-discharge, the overall performance and efficiency of the electrolyte and thereby the performance of the Zinc-bromine redox battery is improved.

In the above embodiment, the electrolyte is prepared in absence of external heat energy, and where the zinc bromide and the tetraethylammonium bromide are present in the ratio of 2:1. Further, the monoethylene glycol is present in molar concentration of about 1.35M. Furthermore, the zinc chloride is present in the molar concentration of about 1.7M and the additional supporting ionic conducting agent is present in the molar concentration of about 3.0M. Additionally, the electrolyte is maintained at a pH value of about 4.7 in absence of pH maintaining agents and buffering agents.

In an implementation, the electrolyte comprises 2.0 molar concentration of zinc bromide and 1.0 M concentration of teteraethylammonium bromide along with other electrolyte ingredients. In certain other embodiment, the electrolyte comprises 2.5 molar concentration of zinc bromide and 1.25 molar concentration of teteraethylammonium bromide along with other electrolyte ingredients.

Many electrolyte compositions with various permutations and combination of zinc bromide to teteraethylammonium bromide were tested, for example, a) 2M zinc bromide and 0.4M TEAB; b) 2M zinc bromide and 0.3M TEAB; c) 2M zinc bromide and 0.3M TEAB; d) 2M zinc bromide, 0.3M TEAB, and other electrolytic ingredients, like potassium chloride, zinc chloride in various concentration, but precipitation of bromozincate ions from solution was observed. Typically, in the presence of zinc bromide, dissolution of TEAB or any other complexing agent, at ambient temperature, at higher concentration (>0.3 M) was challenging and not yet reported as it precipitates out in the form of bromozincate. The precipitation of bromozincate ions from solution occurs when the solution becomes supersaturated with the ions, and they form an insoluble solid that separates from the electrolyte solution.

In accordance with an embodiment, the precipitation of bromozincate ions from solution can be detected using various known methods, which includes the following. a) Visual observation: The appearance of a solid precipitate can be observed with the naked eye; b) pH measurement: The pH of the solution can be measured using a pH meter or indicator paper. A change in pH, particularly an increase in alkalinity, can indicate the precipitation of bromozincate ions; c) Conductivity measurement: The conductivity of the solution can be measured using a conductivity meter. A decrease in conductivity can indicate the formation of an insulating precipitate; d) Spectrophotometry: The concentration of bromo-zincate ions in the solution can be determined using spectrophotometry, by measuring the absorbance of light at a specific wavelength; and e) X-ray diffraction: The crystal structure of the precipitate can be analyzed using X-ray diffraction, which can confirm the presence of bromo-zincate ions in the precipitate.

Certain other quartenary ammonium salts were tested with different ratios, such as Tetramethyammonium bromide, Trimethylphenylammonium bromide, Tetrapropylammonium bromide and Tetrabutylammonium bromide for their efficiency and performance and it was observed that none of them helps in reducing precipitation of bromozincate ions from solution. Although higher solubility of ZnBr₂ enhances the capacity of the battery. However, due to the lower solubility of complexing agents in electrolytes, the battery generally suffers from high self-discharge.

In a preferred embodiment, when the electrolyte composition comprises 2.0M concentration of zinc bromide, 1.0M concentration of TEAB, 1.7M concentration of zinc chloride, 3.0M concentration of ammonium chloride and 1.5M concentration of monoethylene glycol, said TEAB in a surprising effect, arrests the free tribromide ion from aqueous solution of electrolyte in solid form, forming clear electrolyte solution even at a low temperature −15° C.

It is known that the main challenges of the Zinc Bromide flow batteries include (a) low current densities during cycling, (b) dendrite formation, (c) high viscosity of the electrolyte polybromide phase in low states of charge, (d) self-discharge and (e) pH variations during operation. The present disclosure has dealt with the above-mentioned drawbacks. The present disclosure moreover provides high energy efficiency of greater than equal to 85% which can be achieved by using electrolyte as described above, whereas, for zinc bromide chemistry, practically energy efficiency of 65-70% is generally achieved with other prior art reported electrolytes. Further, as the TEAB arrest the tribromide ions in solid form, the electrolyte composition possesses high ionic conductivity and low viscosity, which makes it suitable for practical application.

In an embodiment, the solvent of the electrolyte is water, and no specific acid or alkaline solution is used. In another embodiment, the structure of Zinc-Bromine battery containing said aqueous electrolyte of the present disclosure can be a button battery, a cylindrical battery, a soft pack battery, a battery pack of any shape and size, or a square shell battery.

In an embodiment, the aqueous electrolyte of the Zinc-Bromine battery of the present disclosure is stable at −15° C. to 50° C., which do not require any external energy during its production. In other words, production of bulk quantity electrolytes requires only commercially available magnetic stirrers and some typical lab utensils with no external heat source.

In another embodiment, the Zinc-Bromine battery prepared as per the present disclosure is suitable for zinc bromide energy storage applicable for a range varying from electric three-wheeler to grid storage, wherein the electrolyte is compatible with commercially available AGM separator, PE and PP separator.

In another embodiment, the present disclosure provides Zinc-Bromine battery composed of carbon based bipolar electrodes and an aqueous electrolyte as described above, wherein the electrodes acts as the first and second current collectors and are configured to facilitate the conversion of halide ions to a polyhalide phase at or near the carbon material of the electrochemical cell i.e. battery, and to form a layer of zinc metal on the second surface of the second current collector upon charging of the electrochemical cell.

In one another embodiment, the present disclosure provides Zinc-Bromine battery composed of carbon-based electrodes and electrolyte as described above, wherein said electrolyte provides steady coulombic efficiency of greater than equal to 95% throughout the cycles indicating efficient participation of the redox couples within the applied voltage range. The above said electrolyte further possess long cycling stability of up to 250 cycles at a higher current rate.

The present disclosure will now be described in detail with reference to examples.

### Examples

### General Method of Preparation:

The electrolyte was prepared by uniform mixing of ethylene glycol, zinc chloride, potassium chloride, and water to form a solvent to which was added the required amount of zinc bromide and TEAB (bromine complexing agent) to obtain an electrolyte of (for) the zinc-bromine static battery. The electrolyte was prepared by using mechanical stirring alone without the use of external heat energy.

Example 1: The electrolyte was prepared by uniform mixing of 1.35 M of ethylene glycol, 1.7 M of zinc chloride, 3.0 M of potassium chloride, and water to form a solvent to which was added the 1.6 M of zinc bromide and 0.8M of TEAB (bromine complexing agent) under stirring at ambient temperature.

Example 2: The electrolyte was prepared by uniform mixing of 1.35 M of ethylene glycol, 1.7 M of zinc chloride, 3.0 M of ammonium chloride, and water to form a solvent to which was added 1.6 M of zinc bromide and 0.8 M of TEAB (bromine complexing agent) under stirring at ambient temperature.

Example 3: The electrolyte was prepared by uniform mixing of 1.35 M of ethylene glycol, 1.7 M of zinc chloride, 1.0 M of ammonium chloride, 2.0 M of potassium chloride, and water to form a solvent to which was added the 1.6 M of zinc bromide and 0.8 M of TEAB (bromine complexing agent) under stirring at ambient temperature.

Example 4: The electrolyte was prepared by uniform mixing of 1.35 M of ethylene glycol, 1.7 M of zinc chloride, 3.0 M of potassium chloride, and water to form a solvent to which was added the 2.5 M of zinc bromide and 1.25 M of TEAB (bromine complexing agent) under stirring at ambient temperature.

Example 5: The electrolyte was prepared by uniform mixing of 1.5 M of ethylene glycol, 1.7 M of zinc chloride, 3.0 M of potassium chloride, and water to form a solvent to which was added the 2.0 M of zinc bromide and 1.0 M of TEAB (bromine complexing agent) under stirring at ambient temperature.

Example 6: The electrolyte was prepared by uniform mixing of 1.5 M of ethylene glycol, 1.7 M of zinc chloride, 3.0 M of ammonium chloride, and water to form a solvent to which was added the 2.0 M of zinc bromide and 1.0 M of TEAB (bromine complexing agent) under stirring at ambient temperature.

### Results

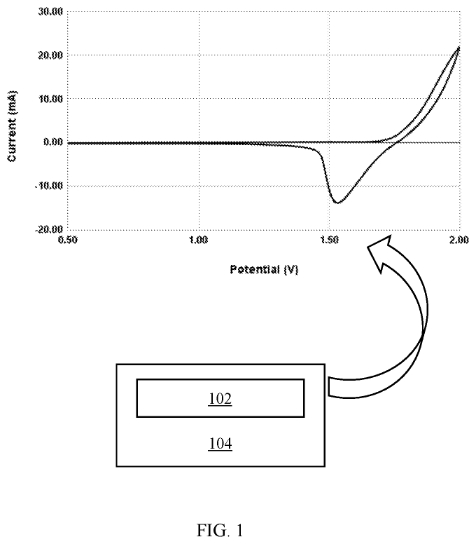

Now, referring to FIG. 1, there is shown a cyclic voltammogram of electrolyte having composition of Example 2 on a full cell carbon/carbon symmetrical cell at a scan rate of 5 mV/s. In this case, the composition of the electrolyte (specified in Example 2) was 1.6 M concentration of zinc bromide, 0.8 M concentration of TEAB, 1.7 M concentration of zinc chloride, 3.0 M concentration of ammonium chloride and 1.35 M concentration of monoethylene glycol. Herein, a pair of characteristic peaks of the zinc-bromide battery was observed at a potential range of 1.5-2.0 V. In the case, the composition of electrolyte 102 manifested a good reversibility. The electrolyte 102 was used for a static zinc-based battery 104. The electrolyte 102 is used for the static zinc-based battery 104 that is applicable for a range varying from electric vehicles, home appliances, to grid storage. The electrolyte 102 is compatible with commercially available Absorbed Glass Mat (AGM) separator, polyethylene (PE), or polypropylene (PP) separator and other applications apart from energy storage.

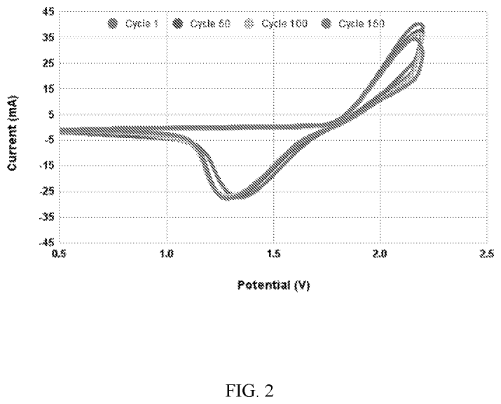

Referring to FIG. 2, there is shown a cyclic voltammogram electrolyte having composition of Example 1 on a full cell carbon/carbon symmetrical cell at a scan rate of 5 mV/s within the potential range 0.5 V to 2.25 V. Herein, Electrolyte shows exceptional stability even at higher cycle (150th) and at large potential range. In this case, the composition of the electrolyte was 1.6 M concentration of zinc bromide, 0.8 M concentration of TEAB, 1.7 M concentration of zinc chloride, 3.0 M concentration of potassium chloride and 1.35 M concentration of monoethylene glycol.

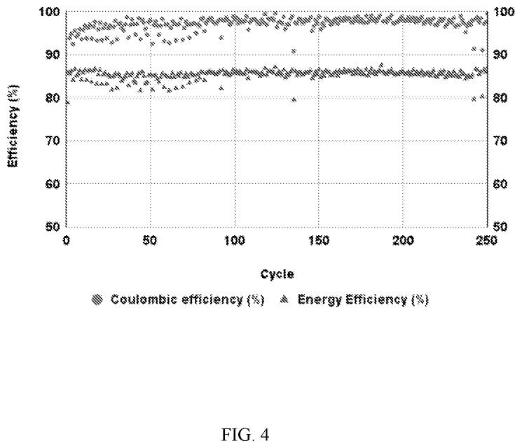

In this embodiment, the electrolyte manifested steady coulombic efficiency of greater than equal to 95% as described in FIG. 4, throughout the cycles indicating efficient participation of the redox couples within the applied voltage range. The electrolyte further possesses long cycling stability of up to 250 cycles at a higher current rate.

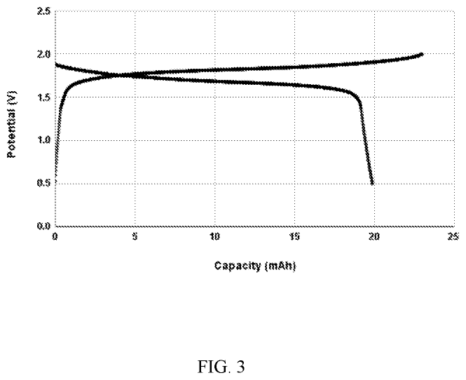

Referring to FIG. 3, there is shown a charge-discharge zinc-bromine static battery profile using the electrolyte and carbon-based electrodes. The voltage and current changes during the charge and discharge cycles of a zinc-bromine battery, which uses a bromine-based electrolyte and carbon electrodes. During the charge process, cell voltage increases gradually as bromine molecules are generated at the positive electrode, while zinc is deposited at the negative electrode simultaneously to store energy. During discharge process, the voltage decreases as the metallic zinc oxidizes to Zn²⁺ ions at the negative electrode and bromine molecules reverse back to bromide ions by reduction at the positive electrode, releasing the energy from the zinc-bromine static battery.

Referring to FIG. 4, there is shown a representation of energy density of a static zinc-bromine battery and long cycling stability using the electrolyte, in accordance with an embodiment of the present disclosure.

For the following molar concentration provided in “Table 1” below and specific ratio between the zinc bromide (ZB) and Tetraethylammonium bromide (TEAB) in the electrolyte, high energy efficiency of greater than equal to 85% was achieved, as shown in FIG. 4. It is to be understood that, for zinc bromide chemistry, practically energy efficiency of 65-70% is generally achieved currently with conventional electrolyte composition. Further, as shown in FIG. 4, a steady coulombic efficiency (>95%) throughout the cycles indicates efficient participation of the redox couples within the applied voltage range when the electrolyte of the present disclosure is used, in the specific molar concentration of its ingredients and ratio of 2:1 maintained between the ZB and the TEAB respectively. Furthermore, higher energy density (average ~85%) of the static zinc-bromine battery (composed of carbon-based electrodes and the electrolyte of Table 1) and long cycling stability (reported up to 250 cycles) at a higher current rate, were observed.

TABLE 1
Aqueous Electrolyte composition of present disclosure

| Electrolyte Component | Concentration (M) | Purpose |
|---|---|---|
| Zinc bromide (ZB) | 1.5M to 3M | The active ingredient that |
| (ZnBr₂) | | takes part in the redox |
| | | reaction. The higher the |
| | | ZB concentration, the |
| | | higher the energy density. |
| Tetraethylammonium | Approximately | This specific ratio of 2:1 |
| bromide (TEAB) | ½ of | between ZB and TEAB |
| (C₈H₂₀NBr) | ZnBr₂ molar | surprisingly causes the |
| | concentration to | TEAB used as a bromine |
| | maintain a ratio | complexing agent to |
| | of 2:1 between | minimize self-discharge |
| | ZB and TEAB | significantly. |
| Monoethylene Glycol | 1M to 2M, | anti-freezing agent |
| (EG) (C₂H₆O₂) | preferably 1.35M | |
| Zinc Chloride (ZC) | 1M to 4M, | supportive electrolyte to |
| (ZnCl₂) | preferably 1.7M | enhance the ionic |
| | | conductivity |
| Potassium Chloride | 2M to 4M, | supportive electrolyte to |
| (PC) (KCl) or | preferably 3M | enhance the ionic |
| Ammonium | | conductivity |
| Chloride (AC) (NH₄Cl) | | |

TABLE 2
The electrolyte compositions were evaluated for their performance based on parameters
such as Energy efficiency, and Number of cycles (recoverable charge):

| | | | | | | Coulombic | Energy |
|---|---|---|---|---|---|---|---|
| Examples | Composition (Molarity) | | | | | efficiency | Efficiency |
| S. No. | ZB | TEAB | EG | ZC | PC/AC | (%) | (%) |
| 1 | 1.6 | 0.8 | 1.35 | 1.7 | PC: 3 | 97 | 85 |
| 2 | 1.6 | 0.8 | 1.35 | 1.7 | AC: 3 | 97 | 83 |
| 3 | 1.6 | 0.8 | 1.35 | 1.7 | PC: 2 AC: 1 | 97 | 85 |
| 4 | 2.5 | 1.25 | 1.35 | 1.7 | PC: 3 | 95 | 75 |
| 5 | 2 | 1 | 1.5 | 1.7 | PC: 3 | 95 | 80 |
| 6 | 2 | 1 | 1.5 | 1.7 | AC: 3 | 95 | 80 |

Here, ZB: Zinc Bromide, TEAB: Teraethylammonium bromide, ZC: Zinc chloride, EG: monoethylene glycol, AC: Ammonium chloride, PC: Potassium chloride.

In an embodiment, the electrolyte comprises 1.6M of the zinc bromide, 0.8M of the tetraethylammonium bromide, 1.35M of the monoethylene glycol, 1.7M of the zinc chloride, and further 3M of the potassium chloride. In such an embodiment, the coulombic efficiency and energy efficiency of the electrolyte were evaluated as 97% and 85% respectively as shown in Table 2.

In another embodiment, the electrolyte comprises 1.6M of the zinc bromide, 0.8M of the tetraethylammonium bromide, 1.35M of the monoethylene glycol, 1.7M of the zinc chloride, and further 3M of the ammonium chloride. In such an embodiment, the coulombic efficiency and energy efficiency of the electrolyte were evaluated as 97% and 83% respectively as shown in Table 2.

In yet another embodiment, the electrolyte comprises 1.6M of the zinc bromide, 0.8M of the tetraethylammonium bromide, 1.35M of the monoethylene glycol, 1.7M of the zinc chloride, and further 2M of the potassium chloride, and 1M of the ammonium chloride. In such an embodiment, the coulombic efficiency and energy efficiency of the electrolyte were evaluated as 97% and 85% respectively as shown in Table 2.

In yet another embodiment, the electrolyte comprises 2M of the zinc bromide, 1M of the tetraethylammonium bromide, 1.5M of the monoethylene glycol, 1.7M of the zinc chloride, and further 3M of the ammonium chloride. In such an embodiment, the coulombic efficiency and energy efficiency of the electrolyte were evaluated as 95% and 80% respectively, as shown in Table 2.

TABLE 3
Synergistic effect of the electrolyte comprising zinc
bromide, tetraethylammonium bromide with
or without another electrolyte ingredient.

| S. No. | Composition | Results |
|---|---|---|
| 1. | ZB-2M, TEAB-0.4M | Precipitation of bromozincate ions |
| | | from solution |
| 2. | ZB-2M, TEAB-0.4M, PC- | Precipitation of bromozincate ions |
| | 3M | from solution |
| 3. | ZB-1M, TEAB-0.5M, ZC- | Precipitation of bromozincate ions |
| | 0.5M | from solution |
| 4. | ZB-2M, TEAB-1M, ZC- | Formation of clear electrolyte |
| | 1.5M | solution |
| 5. | ZB-2M, TEAB-1M, ZC-1.5M | Formation of clear electrolyte |
| | PC-3M | solution at ambient temperature, |
| | | with a higher ionic conductivity |
| | | than combination 4 |
| 6. | ZB-2M, TEAB-1M, ZC- | Formation of clear electrolyte |
| | 1.7M AC-3M EG-1.5M | solution even at a low temperature |
| | | −15° C. |

In an embodiment, the electrolyte comprises 2M of the zinc bromide, 1M of the tetraethylammonium bromide, 1.5M of the monoethylene glycol, 1.7M of the zinc chloride, and further 3M of the ammonium chloride. In such an embodiment, a clear solution of the electrolyte is formed even at a low temperature of −15° C. as shown in Table 3.

TABLE 4
Selection of effective bromine complexing agent using active
material Zinc bromide (2.5M) and supporting electrolyte Zinc
chloride (1.5M). Electrolytes containing the various alternative
bromine complexing agent were tested at bench scale in a full-
cell battery setup under controlled electrolyte flow and temperature.

| Bromine Complexing agent | Results |
|---|---|
| Tetraethylammonium bromide | Dissolution of bromine complexing agent |
| (1.25M) | in a significant amount |
| Tetramethyammonium bromide | Precipitation of bromo-zincate ions from |
| (0.5M) | solution |
| Trimethylphenylammonium | Precipitation of bromo-zincate ions from |
| bromide (0.5M) | solution |
| Tetrapropylammonium bromide | Precipitation of bromo-zincate ions from |
| (0.5M) | solution |
| Tetrabutylammonium bromide | Precipitation of bromo-zincate ions from |
| (0.5M) | solution |
| Trimethylphenylammonium | Precipitation of bromo-zincate ions from |
| bromide (1.25 M) | solution |
| Trimethylphenylammonium | Precipitation of bromo-zincate ions from |
| bromide (1.25M) | solution |
| Tetrapropylammonium bromide | Precipitation of bromo-zincate ions from |
| (1.25M) | solution |
| Tetrabutylammonium bromide | Precipitation of bromo-zincate ions from |
| (1.25M) | solution |

Exemplary embodiments of the disclosure have been disclosed. A person of ordinary skill in the art recognizes that modifications fall within the teachings of this application. Any numerical values recited in the above application include all values from the lower value to the upper value in increments of one unit provided that there is a separation of at least 2 units between any lower value and any higher value. All possible combinations of numerical values between the lowest value and the highest value enumerated are to be considered to be expressly stated in this application. Unless otherwise stated, all ranges include endpoints and all numbers between the endpoints. The use of “about” or “approximately in connection with a range applies to both ends of the range. Thus, “about 20 to 30’ is intended to cover “about 20 to about 30, inclusive of at least the specified endpoints.

1. An electrolyte of a static zinc-based battery, comprising:
a) zinc bromide in molar concentration ranging from 1.5M to 3.0M;
b) tetraethylammonium bromide as a bromine complexing agent in half of the molar concentration of the zinc bromide;
c) a glycol based anti-freezing agent in molar concentration ranging from 1.0M to 2.0M;
d) zinc chloride as supporting ionic conducting agent in molar concentration ranging from 1.0M to 4.0M; and
e) an additional supporting ionic conducting agent in molar concentration ranging from 2.0M to 4.0M.

2. The electrolyte claim 1, wherein the additional supporting ionic conducting agent is selected from potassium chloride or ammonium chloride or a combination thereof.

3. The electrolyte of claim 1, wherein the glycol based anti-freezing agent is selected from the group comprising of monoethylene glycol, propylene glycol, 1,3-butylene glycol, polyethylene glycol 200, polyethylene glycol 400, or a combination thereof.

4. (canceled)

5. The electrolyte of claim 1, wherein the electrolyte is free of pH maintaining agents and buffering agents.

6. The electrolyte of claim 1, wherein the electrolyte comprises 1.6M of the zinc bromide, 0.8M of the tetraethylammonium bromide, 1.35M of the monoethylene glycol, 1.7M of the zinc chloride, and further 3M of potassium chloride.

7. The electrolyte claim 1, wherein the electrolyte comprises 1.6M of the zinc bromide, 0.8M of the tetraethylammonium bromide, 1.35M of the monoethylene glycol, 1.7M of the zinc chloride, and further 3M of ammonium chloride.

8. The electrolyte of claim 1, wherein the electrolyte comprises 1.6M of the zinc bromide, 0.8M of the tetraethylammonium bromide, 1.35M of the monoethylene glycol, 1.7M of the zinc chloride, and further 2M of potassium chloride, and 1M of ammonium chloride.

9. The electrolyte of claim 1, wherein the electrolyte comprises 2M of the zinc bromide, 1M of the tetraethylammonium bromide, 1.5M of the monoethylene glycol, 1.7M of the zinc chloride, and 3M of ammonium chloride.

10. The electrolyte of claim 1, wherein the electrolyte comprises 2M of the zinc bromide, 1M of the tetraethylammonium bromide, 1.5M of the monoethylene glycol, 1.7M of the zinc chloride, and 3M of ammonium chloride.
